(19) United States
(12) Patent Application Publication
(10) Pub. No.: US 2023/0059498 A1
(43) Pub. Date: Feb. 23, 2023

(54) ANTI-LOOSENING FASTENER

(71) Applicant: HI-LEX CONTROLS, INC., Rochester Hills, MI (US)

(72) Inventors: SHIGEKI ARIMOTO, BLOOMFIELD HILLS, MI (US); HIROSHI MASUDA, ROCHESTER HILLS, MI (US)

(73) Assignee: HI-LEX CONTROLS, INC., ROCHESTER HILLS, MI (US)

(21) Appl. No.: 17/407,262

(22) Filed: Aug. 20, 2021

(51) Int. Cl. F16B 21/02

(52) U.S. Cl. CPC F16B 21/02

(57) ABSTRACT

A fastener includes a male member having a head and a threaded portion protruding from the head along a longitudinal axis, and a female member having a body portion and a tubular tightening portion extending from the body portion along the longitudinal axis. The tubular tightening portion includes a thread bore receiving the threaded portion of the male member and a plurality of teeth formed on an outer surface of the tubular tightening portion. Further, the male member includes at least one arm extending form the head along the longitudinal axis, and the at least one arm of the male member includes a projection protruding radially inward from the arm and engaging the teeth of the female member.

### TECHNICAL FIELD

This present disclosure relates to a fastener, and in particular, to a mechanical fastener with an anti-loosening feature.

### BACKGROUND

The statements in this section merely provide background information related to the present disclosure and may not constitute prior art.

Numerous fasteners are well known and commercially available for connecting two or more members together. Typical fasteners of this general type include the conventional threaded nuts and bolts such that a threaded bolt is rotationally coupled to a nut to connect and fasten two members. However, we have discovered that a problem raised by the fastening mode of a structural assembly with threaded fasteners is that of loosening in use, generally due to an external condition such as vibration.

It is known practice to use fasteners with various anti-loosening features to avoid loosening of the fasteners due to vibration. However, we have further discovered that the ordinary fasteners with the anti-loosening features for connecting two members would be ineffective and inconvenient, and also expensive in certain manufacturing operations. Accordingly, there is constantly a desire to have an anti-loosening fastener connected between at least two members and also simplify the manufacturing operations. In addition, when the anti-loosening fastener is used in a vehicle, there is a desire to reduce cost and weight as an automotive component, while providing a desirable durability, low warranty claims, and compliance with performance requirements.

### SUMMARY

The present disclosure relates to a mechanical fastener having anti-loosening features. When the male member of the fastener is rotationally coupled to the female member, the anti-loosening features formed in each of the male and female members are securely engaged with each other such that the fastener is prevented from loosening under external conditions such as vibration. The mechanical fastener having the anti-loosening feature of the present disclosure is generally applied to the various vehicle components such as a window regulator assembly and/or a door lock/handle assembly. Accordingly, the mechanical fastener of the present disclosure is prevented from loosening as well as reduces weight and cost of the vehicle component assembly.

According to an exemplary embodiment of the present disclosure, the fastener includes a male member having a head and a threaded portion protruding from the head along a longitudinal axis and a female member having a body portion and a tubular tightening portion extending from the body portion along the longitudinal axis. The tubular tightening portion includes a thread bore receiving the threaded portion of the male member and a plurality of teeth formed on an outer surface of the tubular tightening portion. The male member further includes at least one arm extending from the head along the longitudinal axis and the at least one arm of the male member includes a projection protruding radially inward from the arm and engaging the teeth of the female member.

According to a further aspect of the present disclosure, the plurality of teeth formed on the outer surface of the tubular tightening portion extends along a longitudinal length of the tubular tightening portion. The teeth are each formed with a substantially polygonal shape and a cavity is formed between adjacent teeth along a circumferential direction of the tubular tightening portion. When the cavity is symmetrically formed with an angle and receives the projection of the male member sized to fit in the cavity. The angle formed in the cavity is generally 90 degrees.

According to a further aspect of the present disclosure, the teeth are each formed with a slanted shape such that the cavity is asymmetrically formed with an angle. The slanted teeth of the female member is configured for allowing the male member is configured for allowing the male member to rotate in one direction, but for preventing the male member to rotate in an opposite direction. The slanted teeth of the female member is configured for allowing the male member to rotate in one direction, but for restricting the male member from rotating in a reverse (an opposite) direction.

According to a further aspect of the present disclosure, the projection of the male member is formed in a distal end of the arm and securely tightened to the plurality of teeth of the female member such that the fastener is prevented from loosening.

According to a further aspect of the present disclosure, the fastener includes a lock piece placing around the at least one arm and slidably moving between an unlocked position and a locked position along the longitudinal axis. In the unlocked position of the lock piece, the lock piece is located in a proximal end of the at least one arm, and in the locked position of the lock piece, the lock piece is located in a distal end of the at least one arm. In addition, the male member is formed of a plastic material and the female member is formed of a plastic or a steel material.

According to a further aspect of the present disclosure, the fastener having the anti-loosening feature is used in various vehicle parts such as a window regulator assembly and/or a door lock/handle assembly

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a perspective view of a fastener having a male member and a female member in accordance with a first embodiment of the present disclosure, FIG. 1A shows a perspective view of the fastener of FIG. 1, and FIG. 1B shows a cross-cut view taken along line 1B-1B of FIG. 1A;

FIG. 2 shows a perspective view of a fastener having a male member and a female member in accordance with a second embodiment of the present disclosure, FIG. 2A shows a perspective view of the fastener of FIG. 2, and FIG. 2B shows a cross-cut view taken along line 2B-2B of FIG. 2A;

FIG. 3 shows a perspective view of the fastener having a lock piece in an unlocked position in accordance with another embodiment of the present disclosure, and FIG. 3A shows a perspective view of the fastener having the lock piece in a locked position of FIG. 3;

FIG. 4 shows a perspective view of a fastener having two male members and a central nut, and FIG. 4A shows a perspective view of the fastener having both male members coupled to the central unit of FIG. 4;

FIG. 5 shows a plan view of a window regulator assembly having the fastener of FIG. 1, and FIG. 5A shows a detailed view of the fastener installed in the window regulator assembly of FIG. 5; and

FIG. 6 shows a plan view of a door lock/handle cable assembly having the fastener of FIG. 1, and FIG. 6A shows a detailed view of the fastener installed in the door lock/handle cable assembly of FIG. 6.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

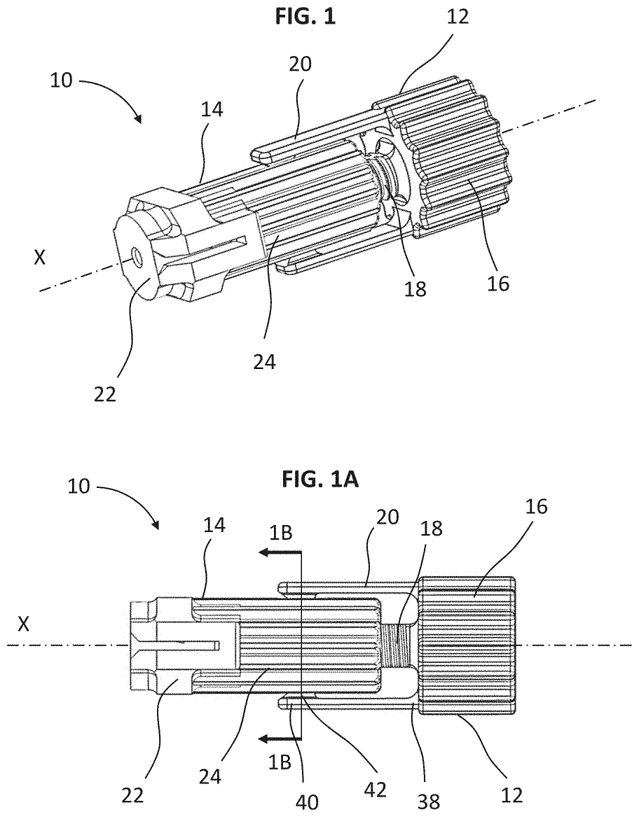

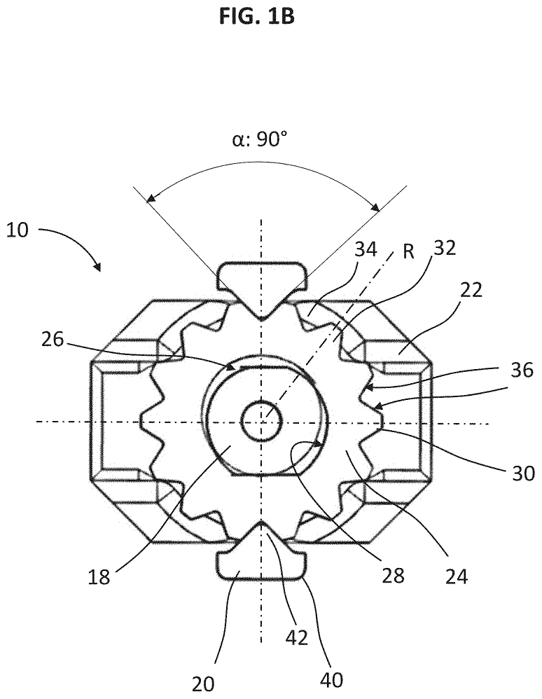

FIGS. 1 and 1A show a fastener 10 including a male member 12 and a female member 14. The male member 12 has a substantially cylindrical shape, and includes a head 16 and a threaded portion 18 extending from the head 16 along a longitudinal axis X of the fastener 10. In another approach, the head 16 of the male member 12 has a polygonal shape (e.g., a hexagonal shape or a rectangular shape). As shown in FIGS. 1 and 1A, the dimension of the head 16 is greater than the dimension (e.g., a diameter) of the threaded portion 18. The male member 12 further includes at least one arm 20 extending from the head 16 along the longitudinal axis X of the fastener 10. For example, as shown in FIGS. 1 and 1A, the male member 12 includes a pair of arms 20 extending from a radial surface portion of the head 16 along the longitudinal axis X such that the pair of arms 20 are spaced to each other and also the threaded portion 18 arranged between the pair of arms 20 transversely in the longitudinal axis X of the fastener 10.

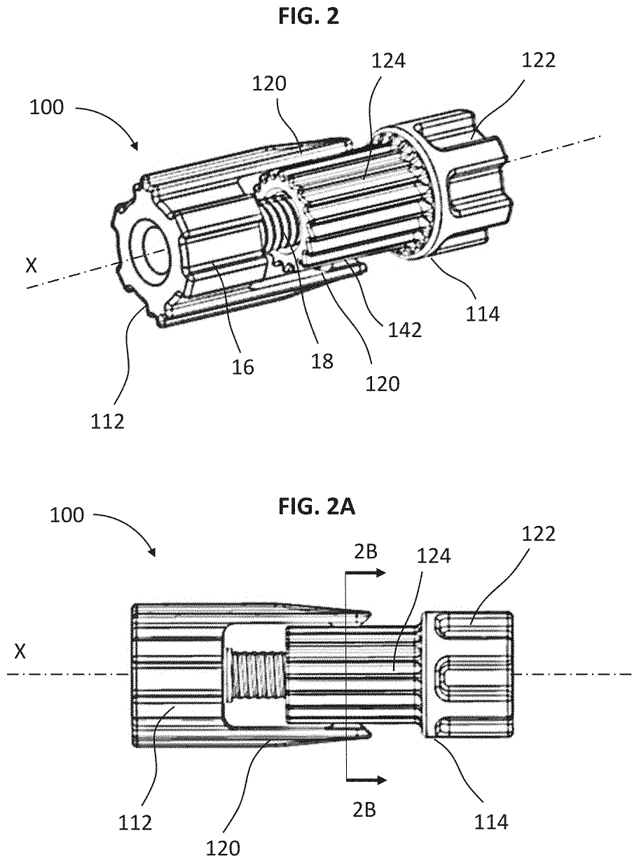

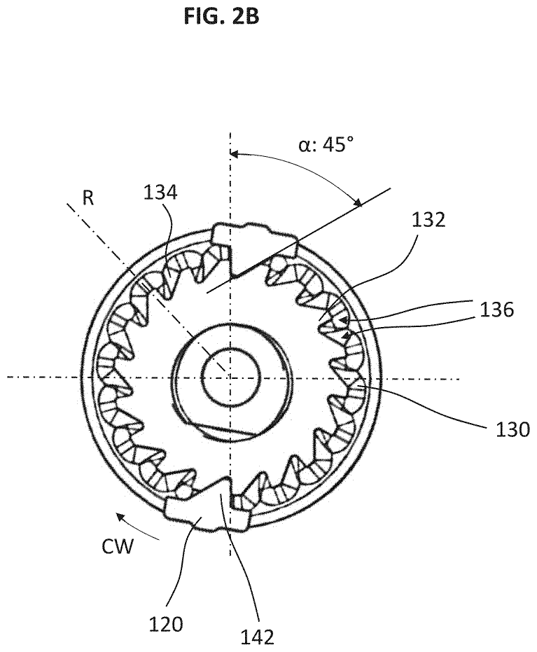

In FIGS. 1 and 1A, the fastener 10 further includes the female member 14 also formed with a substantially cylindrical shape. The female member 14 includes a body portion 22 and a tubular tightening portion 24 extending from the body portion 22 along the longitudinal axis X. As shown in FIG. 1B, the body portion 22 of the female member 14 has a polygonal shape (e.g., a hexagonal shape or a rectangular shape). In another approach, the body portion 22 of the female member 14 can be formed with a substantially circular shape (see FIGS. 2 and 2A). In FIG. 1B, the outer diameter (dimension) of the body portion 22 is generally greater than the outer diameter (dimension) of the tubular tightening portion 24. As shown in FIGS. 1 and 1B, further, the tubular tightening portion 24 of the female member 14 is formed with a tubular shape such that the tubular tightening portion 24 includes a thread bore 26 with an inner surface 28 and an outer surface 30.

In FIGS. 1 and 1A, when the male member 12 is rotationally coupled to the female member 14, the threaded portion 18 of the male member 12 and the tubular tightening portion 24 of the female member 14 are securely engaged to fasten each other. As shown in FIGS. 1A and 1B, the thread bore 26 of the female member 14 is sized to receive the threaded portion 18 of the male member 12. Further, the tubular tightening portion 24 includes the inner surface 28 formed with helical threads to rotationally engage the threaded portion 18 of the male member 12 when the male member 12 is coupled to the female member 14. In FIG. 1B, the tubular tightening portion 24 further includes the outer surface 30 formed with a plurality of teeth 32 around the circumference of the tubular tightening portion 24. The teeth 32 formed on the outer surface 30 extends to an end of the tubular tightening portion 24 from the body portion 22 along the longitudinal length of the tubular tightening portion 24.

FIG. 1B shows a cross-cut view of the fastener 10 having the male member 12 and the female member 14. As shown in FIG. 1B, the outer surface 30 of the tubular tightening portion 24 is formed with the plurality of teeth 32, and each tooth 32 is formed with a substantially polygonal shape (e.g., a trapezoidal shape) in the cross-section of the fastener 10. In another approach, the tooth 32 can be formed with a substantially triangular shape. In addition, as shown in FIG. 1B, the polygonal shape of each tooth 32 is symmetric about a radial axis R. In another approach, the polygonal shape (or the triangular shape) of the tooth 132 is asymmetric about the radial axis R (see FIG. 2B).

Further, in the cross-cut view of the tubular tightening portion 24, a cavity 34 is formed between adjacent two of the plurality of teeth 32 around the circumferential direction of the tubular tightening portion 24. As shown in FIG. 1B, the cavity 34 is symmetrically formed with an angle a between the side surfaces 36 with a same length of the adjacent two teeth 32. For example, in FIG. 1B, the cavity angle a is 90 degrees. In another approach, however, the cavity angle a can be different angles such as 30, 45, and 60 degrees. In the second embodiment of FIG. 2B, each tooth 132 is formed with a slanted shape such that the side surfaces 136 of the adjacent two teeth 132 have different lengths. Further, the cavity 134 between the slanted teeth 132 is asymmetrically formed with a cavity angle a (e.g., 45 degrees). Accordingly, in the fastener 100 of FIG. 2B, the male member 112 can be rotated only in one direction (e.g., a clockwise (CW) direction), but cannot be rotated in its reversed (opposite) direction (e.g., a counter-clockwise (CCW) direction), which will be described later.

Furthermore, each arm 20 has a proximal end 38 attached to the head 16 and a distal end 40 extending from the head 16 along the longitudinal axis X as shown in FIGS. 1 and 1A. Each arm 20 includes a projection 42 formed at the distal end 40 of the arm 20. In FIGS. 1 and 1B, the projection 42 protruding inward from the arm 20 along the radial axis R such that the projection 42 is sized to fit in the cavity 34 formed between the teeth 32. When the male member 12 is rotationally coupled to the female member 14, the projection 42 of the arm 20 can rotate over the plurality of teeth 32 with certain torque until the male member 12 is fastened to the female member 14. After the male member 12 is fastened to the female member 14, the projection 42 of the male member is securely engaged with the cavity 34 formed between the teeth 32 of the female member 14 such that the fastener 10 of the present disclosure can prevent the male member 12 from loosening due to the external condition such as vibration.

The male member 12 is generally made of a plastic material such that the pair of arms 20 formed with the male member 12 is flexible and the male member 12 can be rotated with certain torque when the male member 12 is rotationally coupled with the female member 14. Also, the female member 14 is made of a steel or plastic material such that the female member 14 supports the load of the male member 12 when the male member 12 is engaged and tightened to the female member 14.

As described above, FIGS. 2 and 2A show a perspective and plan view of the fastener 100 according to the second embodiment of the present disclosure, and FIG. 2B shows a cross-cut view of the fastener 100. It is to be appreciated that the like elements are given the same reference numeral and thus a further detailed description concerning those items is not provided. Compared to the fastener 10 of the first embodiment, the fastener 100 of the second embodiment has the different shape of the body portion 122 of the female member 114 and also the different shape of the tooth 132 formed in the outer surface of the tubular tightening portion 124. In the cross-section of the fastener 100, as shown in FIG. 2B, the polygonal shape (or the triangular shape) of the tooth 132 is asymmetric about the radial axis R such that the cavity 134 between the adjacent two of the plurality of teeth 132 is formed with the slanted shape. In FIG. 2B, the cavity angle a is 45 degrees, but in another approach, the cavity angle a has different values such as 30 and 60 degrees.

Further, in FIG. 2B, the projection 142 of the arm 120 in the second embodiment of the present disclosure is also sized to fit in the slanted cavity 134 formed between the adjacent asymmetric teeth 132. Accordingly, the projection 142 of the arms 120 can be rotated over the teeth 132 when the male member 112 is rotated in one direction (e.g., a CW direction), but the projection 142 of the arms 120 cannot be rotated over the teeth in a reverse (opposite) direction (e.g., a CCW direction) as shown in FIG. 2B. In another approach, the fastener 100 can be rotated in a CCW direction, but cannot be rotated over the teeth in a CW direction. As described above, the fastener 100 having the asymmetric teeth 132 on the outer surface 130 of the tubular tightening portion 124 is configured to operate as a latchet system according to the second embodiment of the present disclosure, and further the fastener 100 in the second embodiment also prevents the male member 112 from loosening due to the vibration.

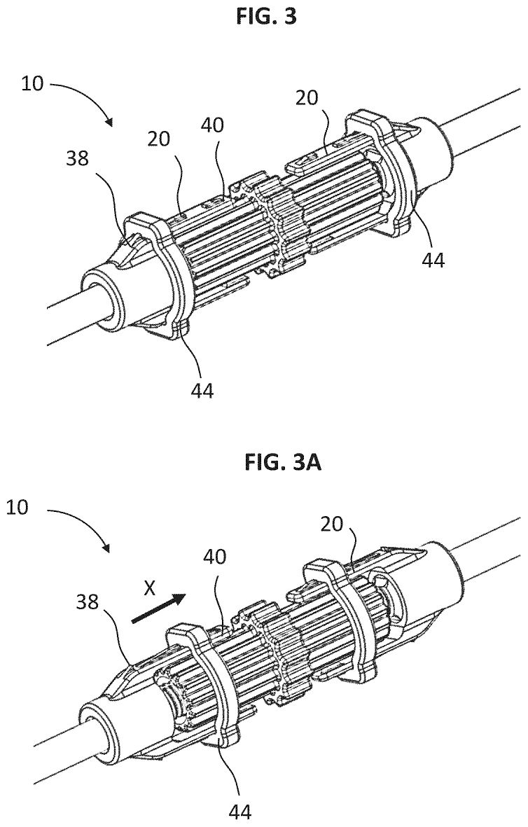

In FIGS. 3 and 3A, the fastener 10 further includes a lock piece 44 to hold the projections 42 of the pair of arms 20 inside the cavity 34 formed between the teeth 32 of the female member 14. The lock piece 44 is generally made of a plastic material and has a substantial ring shape. As shown in FIGS. 3 and 3A, the lock piece 44 is arranged around the pair of arms 20 of the male member 12 and moves between an unlocked position and a locked position along the longitudinal axis X of the fastener 10. In the unlocked position of the lock piece 44, the lock piece 44 is located in the proximal end 38 of the arm 20, and in the locked position, the lock piece 44 is moved to the distal end 40 of the arm 20. Accordingly, in the locked position, the lock piece 44 is configured to hold the projections 42 of the arms to stop the rotational movement of the male member 12 such that the fastener 10 is further prevented from loosening due to the external conditions (e.g., vibration).

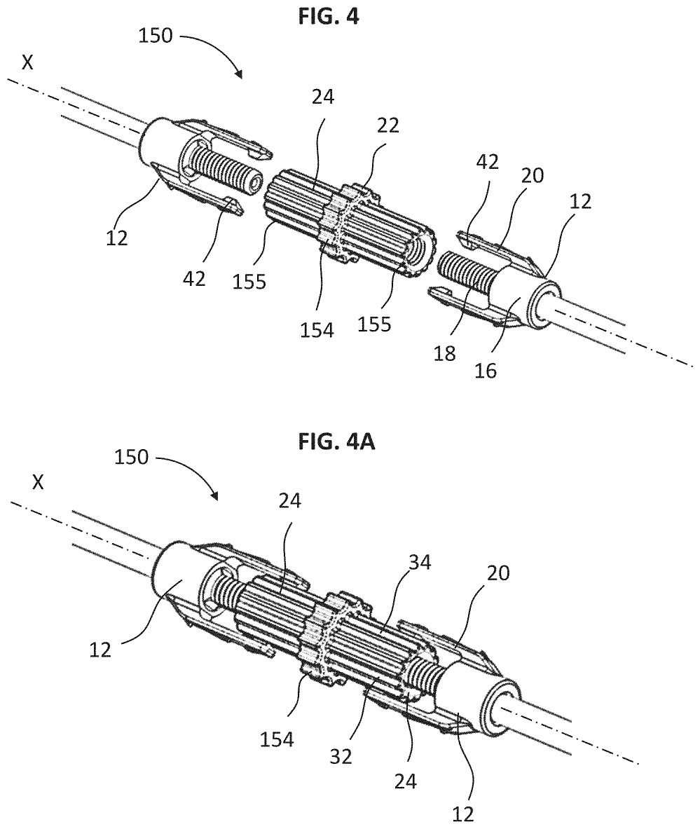

FIG. 4 shows a turnbuckle system 150 having the fastener 10 of the present disclosure as described above. An ordinary turnbuckle system used as a tensioning means tends to slack or loosen cables or rods attached to the turnbuckle system under conditions of vibration and/or variation of the temperature. Accordingly, as shown in FIG. 4, the turnbuckle system 150 having the feature of the fastener 10 is prevented from loosening or slacking under the condition of the vibration. In FIG. 4, the turnbuckle system 100 includes a pair of male members 12 and one female member 14 receiving each of the male members 12 in both ends 155 of the female member 14 for fastening a product (not shown). The female member 14 includes a central nut 154 having a substantially cylindrical shape and both ends 155 having tubular tightening portion 24 to receive the pair of male members 12 respectively. The heads 16 of the pair of male members 12 is each connected to an object (e.g., cable or rod), and the threaded portion 18 of the male member 12 is rotationally engaged with the tubular tightening portion 24 formed in both ends 155 of the female member 14.

As shown in FIG. 4A, the pair of arms 20 of the male member 12 is rotated over the a plurality of teeth 32 formed in the outer surface 30 of the tubular tightening portion 24 with certain torque when the male member 12 is rotationally coupled to the tubular tightening portion 24. Further, the projections 42 formed in the pair of arms 20 of the male members 12 are each sized to fit in the cavity 34 formed in the tubular tightening portion 24 such that the turnbuckle system 150 having the anti-loosening feature of the fastener 10 described above can prevent the male members 12 connected with the cable or rod from loosening under the external condition (e.g., vibration). In FIG. 4, the turnbuckle system 150 further includes the lock piece 44 (see FIGS. 3 and 3A) to arrange over the pair of arms 20 to prevent the rotational movement of the male member 12 by moving the lock piece 44 toward the locked position along the longitudinal axis X of the fastener 10.

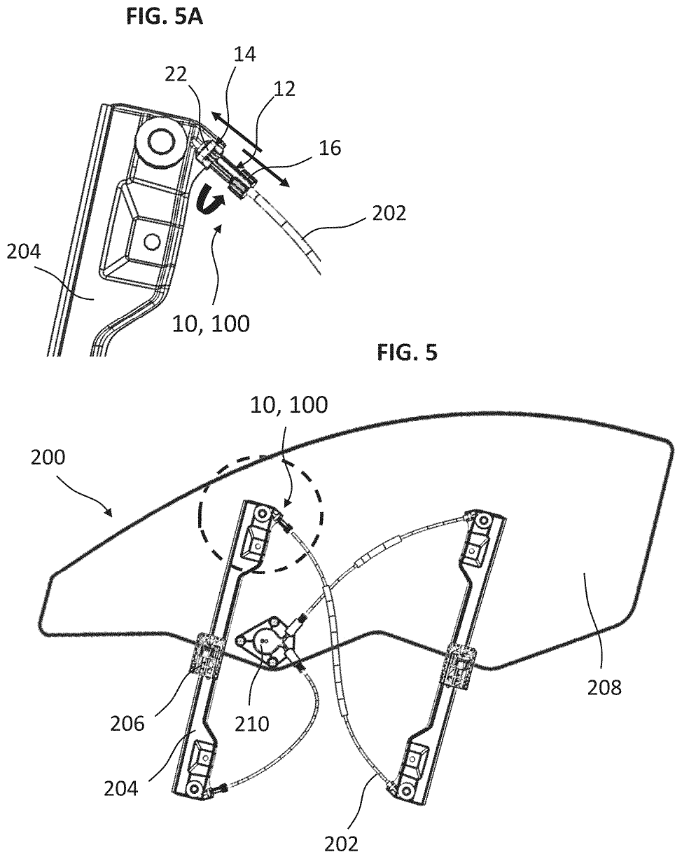

FIG. 5 shows a window regulator assembly 200 for moving a vehicle window 208 up and down in a vehicle. As shown in an example of FIG. 5, the window regulator assembly 200 includes a drive motor (not shown), drive cables 202, guide rails 204, glass lift plates 206, and a vehicle window 208. The drive motor is mounted to a cable drum housing plate 210 and drives vertical movement of the glass lift plates 206 on the guide rails 204 respectively by means of the drive cables 202. Each of the drive cables 202 is connected to the guide rails 204 by the fastener 10 of the present disclosure and is adapted to adjust the tilt of the vehicle window 208 in the fore/aft direction of the vehicle by changing the length of the drive cables 202. Accordingly, after adjusting the final tilt position of the vehicle window 208, the drive cables 202 connected to the fastener 10 keeps the final tilt position of the vehicle window 208 and are prevented from loosening or slacking under external conditions.

FIG. 5A shows a detailed view of the drive cables 202 securely connected to the guide rails 204 by the fastener 10 described above in the present disclosure. As shown in FIG. 5A, the body portion 22 of the female member 14 has a substantially rectangular shape (see FIG. 1), which is sized to securely attach the female member 14 to the guide rail 204, and the drive cable 202 is fixedly connected to the head 16 of the male member 12 such that each of the drive cables 202 is securely connected to the guide rails 204 by the fastener 10 having the anti-loosening feature. Accordingly, due to the drive cable 202 connected to the fastener 10 having the anti-loosening feature of the present disclosure, the drive cable 202 can be prevented from loosening under the external condition such as vibration, etc. In addition, the fastener 10 used in the connection between the guide rail 204 and the drive cable 202 is configured to adjust and lock the effective length of the drive cable 202 for the tilt position of the vehicle window 208.

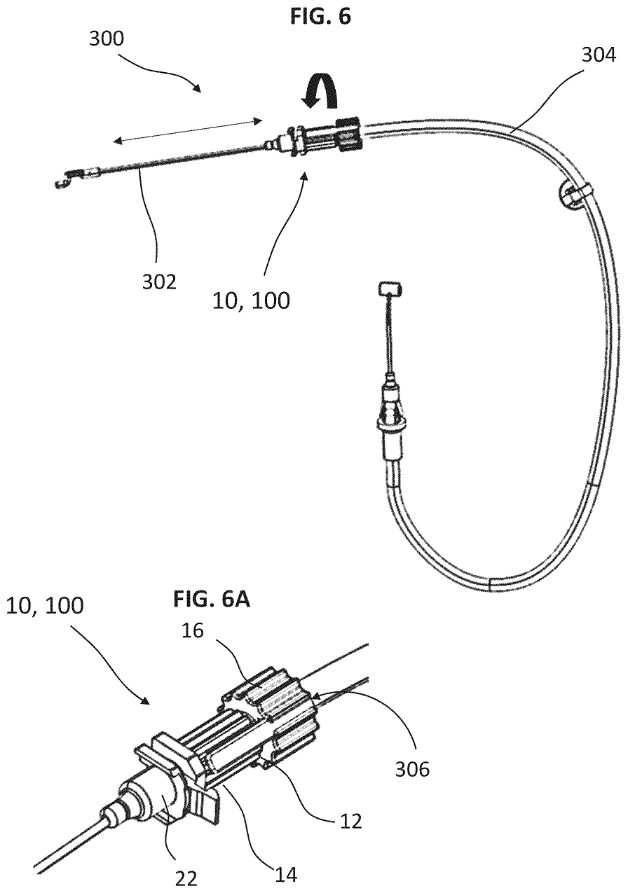

FIG. 6 shows a door lock/handle cable assembly 300 used in a door assembly in a vehicle. The door lock/handle cable assembly 300 includes a cable core 302, a cable insulator 304, and the fastener 10 having an anti-loosening feature. Further, the fastener 10 of the present disclosure can adjust the length of the cable core 302 as an adjuster when the door lock/handle cable 300 is assembled in the door. As described above, the door lock/handle cable assembly 300 includes the fastener 10 having the anti-loosening feature such that, after the length of the cable core 302 is adjusted during the assembly, the cable core 302 is locked with a constant length by the fastener 10 arranged at an end of the cable insulator 304.

FIG. 6A shows a detailed view of the fastener 10 used in the door lock/handle assembly 300. The fastener 10 used in the door lock/handle assembly 300 has the male member 12 and the female member 14. Each of the male member 12 and the female member 14 is formed with a central bore 306 for passing the cable core 302. Further, the body portion 22 of the female member 14 is securely attached to a portion of the door assembly and the head 16 of the male member 12 is securely connected to the cable insulator 304 such that the length of the cable core 302 is adjusted during the assembly, and also due to the fastener 10 having the anti-loosening feature, the cable core 302 of the door lock/hand cable assembly 300 is prevented from loosening due to the external condition such as vibration. Accordingly, the fasteners 10 and 100 having an anti-loosening feature of the present disclosure are generally used in various vehicle component assemblies.

While the above description constitutes the preferred embodiments of the present invention, it will be appreciated that the invention is susceptible to modification, variation and change without departing from the proper scope and fair meaning of the accompanying claims.

What is claimed is:

1. A fastener comprising:
a male member having a head and a threaded portion protruding from the head along a longitudinal axis, the male member further including at least one arm extending from the head along the longitudinal axis; and
a female member having a body portion and a tubular tightening portion extending from the body portion along the longitudinal axis,
wherein the tubular tightening portion includes a thread bore receiving the threaded portion of the male member and a plurality of teeth formed on an outer surface of the tubular tightening portion, and
wherein the at least one arm of the male member engages the teeth of the female member.

2. The fastener of claim 1, wherein the at least one arm of the male member includes a projection protruding radially inward from the arm.

3. The fastener of claim 1, wherein the plurality of teeth formed on the outer surface of the tubular tightening portion extends to an end of the tubular tightening portion from the body portion along the longitudinal axis.

4. The fastener of claim 1, wherein the teeth are each formed with a substantially polygonal shape and a cavity is formed between adjacent teeth along a circumferential direction of the tubular tightening portion.

5. The fastener of claim 4, wherein the cavity is symmetrically formed with an angle and receives a projection of the male member sized to fit in the cavity.

6. The fastener of claim 5, wherein the angle formed in the cavity is generally 90 degrees.

7. The fastener of claim 4, wherein the teeth are each formed with a slanted shape such that the cavity is asymmetrically formed with an angle.

8. The fastener of claim 7, wherein the slanted teeth of the female member is configured for allowing the male member to rotate in one direction, but for restricting the male member from rotating in a reverse direction.

9. The fastener of claim 2, wherein the projection of the male member is formed in a distal end of the arm and securely tightened to the plurality of teeth of the female member such that the fastener is prevented from loosening.

10. The fastener of claim 1, wherein the fastener further includes a lock piece placing around the at least one arm and slidably moving between an unlocked position and a locked position along the longitudinal axis.

11. The fastener of claim 10, wherein, in the unlocked position of the lock piece, the lock piece is located in a proximal end of the at least one arm, and in the locked position of the lock piece, the lock piece is located in a distal end of the at least one arm.

12. The fastener of claim 1, wherein the male member is formed of a plastic material.

13. The fastener of claim 1, wherein the female member is formed of a plastic or a steel material.

14. A fastener for use in a window regulator having a guide rail and a drive cable, the fastener comprising:
a male member having a head receiving the drive cable and a threaded portion protruding from the head along a longitudinal axis, the male member further including at least one arm extending from the head along the longitudinal axis; and
a female member having a body portion fixedly attached to the guide rail and a tubular tightening portion extending from the body portion along the longitudinal axis,
wherein the tubular tightening portion of the female member includes a thread bore receiving the threaded portion of the male member and a plurality of teeth formed on an outer surface of the tubular tightening portion, and
wherein the at least one arm of the male member includes a projection protruding radially inward from the arm and engaging the teeth of the female member.

15. The fastener of claim 14, wherein the projection of the male member is formed with a distal end of the arm and securely tightened to the plurality of teeth of the female member such that the fastener is configured to prevent the drive cable from loosening and also adjust a length of the drive cable.

16. A fastener for use in a vehicle door lock/handle assembly having a cable insulator and a trim panel, the fastener comprising:
a male member having a head connected to the cable insulator and a threaded portion protruding from the head along a longitudinal axis, the male member further including at least one arm extending from the head along the longitudinal axis; and
a female member having a body portion fixedly attached to the trim panel and a tubular tightening portion extending from the body portion along the longitudinal axis,
wherein the tubular tightening portion of the female member includes a thread bore receiving the threaded portion of the male member and a plurality of teeth formed on an outer surface of the tubular tightening portion, and
wherein the at least one arm of the male member includes a projection protruding radially inward from the arm and engaging the teeth of the female member.

17. The fastener of claim 16, wherein the projection of the male member is formed with a distal end of the arm and securely tightened to the plurality of teeth of the female member such that the fastener is configured to prevent the door lock cable from loosening and also adjust a length of the door lock cable.
